(19) United States
(12) Patent Application Publication
(10) Pub. No.: US 2010/0161952 A1
(43) Pub. Date: Jun. 24, 2010

(54) PERFORMANCE OPTIMIZATIONS BY DYNAMIC REDUCTION OF FILE ALLOCATION TABLES

(75) Inventors: KESHAVA MUNEGOWDA, Bangalore (IN); Prabhu Ramanathan Babu, Chinnalapatti (IN); Suresh Reddy Allam, Bangalore (IN); Veeramanikandan Raju, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/337,627

(22) Filed: Dec. 18, 2008

(51) Int. Cl. G06F 15/177

(52) U.S. Cl. 713/2

(57) ABSTRACT

Performance optimizations by dynamic reduction of file allocation tables (FAT). A method of a file system includes reading a boot sector to determine a count of FAT instances. The method may set a count of FAT instances referred to in a boot sector to one if the count is greater than one. The method may modify the boot sector to refer to a data sector including a FAT instance as a reserved data sector. In addition, the method may include setting the count of FAT instances to one during at least one of a periodic operation of a dedicated application program interface and a file system mounting.

### FIELD OF TECHNOLOGY

This disclosure relates generally to a computer file system and more particularly to performance optimizations of file allocation tables.

### BACKGROUND

A file allocation table (FAT) file system will often include a multiplicity of FATs in order to provide redundancy. Redundancy is provided for the FAT file system so that if a data sector is corrupted in one of the FATs, that data is not lost because it is duplicated in the other FAT. This redundancy is not necessary in a flash device. This is due to the fact that flash memories require block management software to perform logical block to physical block mapping and wear-leveling. Additionally, the redundancy consumes additional system resources and thus degrades the performance of the FAT file system. Furthermore, the flash device has a limited number of possible read or write operations. Therefore, the redundancy also shortens the life of the flash device.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

Several methods and a system of performance optimizations by dynamic reduction of FATs are disclosed.

An exemplary embodiment provides a method for performance optimizations of FATs. The method includes reading a boot sector to determine a count of FAT instances. The method includes setting a count of FAT instances referred to in a boot sector to one if the count is greater than one. The method modifies the boot sector to refer to a data sector including a FAT instance except a last FAT instance as a reserved data sector.

An exemplary embodiment provides a system for performance optimizations of FATs. The system includes a computer file system with a driver module to read a boot sector to determine a count of FAT instances. The computer file system includes a boot module to modify the boot sector to refer to a data sector including a FAT instance except a last FAT instance as a reserved data sector. A file module sets a count of FAT instances referred to in a boot sector to one if the count is greater than one.

Another exemplary embodiment provides another method for performance optimizations of FATs. The method includes configuring a microprocessor to read a boot sector to determine a count of FAT instances. The method configures a microprocessor to set a count of FAT instances referred to in a boot sector to one if the count is greater than one. The method configures the microprocessor to modify the boot sector to refer to a data sector including a FAT instance except a last FAT instance as a reserved data sector. In addition, the method may also configure the microprocessor to change a reserved data sector count in the boot sector to equal a sum of the FAT instances located in the reserved data sector.

The methods and system disclosed herein may be implemented in any means for achieving various aspects, and may be executed in a form of a machine-readable medium embodying a set of instructions that, when executed by a machine, cause the machine to perform any of the operations disclosed herein. Other aspects and example embodiments are provided in the Drawings and the Detailed Description that follows.

### BRIEF DESCRIPTION OF THE VIEWS OF DRAWINGS

FIG. 1 is a system view of a computer file system illustrating a FAT communicating with a data processing unit, according to one embodiment.

FIG. 2 is a system view of a computer file system array illustrating reduction of FAT instances to one, according to another embodiment.

FIG. 3 is a process flow illustrating a method for performance optimizations of FATs, according to one embodiment.

FIG. 4 is a process flow illustrating a method of configuring a microprocessor to implement a method for performance optimizations of FATs, according to another embodiment.

### DETAILED DESCRIPTION

Several methods and a system of performance optimizations by dynamic reduction of FATs are disclosed. Although the embodiments have been described with reference to specific example embodiments, it will be evident that various modifications and changes may be made to these embodiments without departing from the broader spirit and scope of the various embodiments.

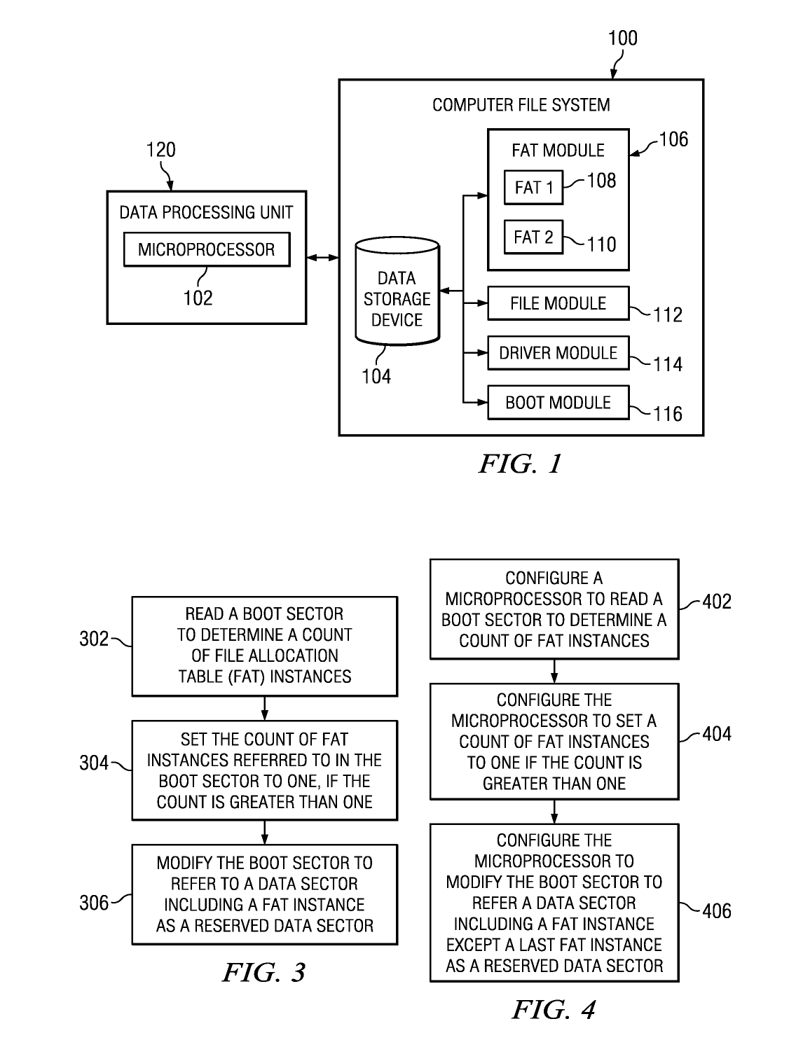

FIG. 1 is a system view of a computer file system 100, according to one embodiment. Particularly, FIG. 1 illustrates a computer file system 100, a microprocessor 102, a data storage device 104, a FAT module 106, a FAT1 108, a FAT2 110, a file module 112, a driver module 114, a boot module 116, and a data processing unit 120 according to one embodiment.

The computer file system 100 may include the data storage device 104. The data storage device 104 may include any computer components, devices, and recording media that retain digital data. The computer file system 100 may set up the root directory and subsequent subdirectories. The computer file system 100 may also create new files or folders which are added to different parts of a file tree on the data storage device 104. The microprocessor 102 may be a machine that can execute computer programs and is the integrated circuitry on a tiny piece of silicon that processes the instructions to make a computer work. In a flash device, the microprocessor 102 may be the patch that processes data at specified intervals or in response to changing input values.

The data storage device 104 may be included in a data processing unit. The data storage device 104 may be implemented on a single-chip mobile device platform which may organize the files on the data storage device 104. The data storage device 104 may be a solid-state device flash drive. The data storage device 104 may receive and retain data for subsequent retrieval and may be used for storing programs or other data. The data storage device 104 may include both volatile memory and non-volatile memory.

The FAT module 106 may organize how specific files or subdirectories are allocated to particular clusters. The FAT module 106 may implement one or more FAT computer file system architectures. For example, FIG. 1 illustrates the FAT module 106 with two FAT computer file systems assigned the markers of FAT1 108 and FAT2 110. The markers are assigned within a boot sector 206A-B. A FAT computer file system may include an index with a list of entries that map to a set of clusters of a directory. A FAT may be associated with one or more data sectors of the data storage device 104.

The file module 112 may set a count of FAT instances 204A-B referred to in a boot sector 206A-B to one if the count is greater than one. The file module 112 may change a boot sector 206A-B to refer another data sector including a last FAT instance as including a new first FAT instance. For example, the computer file system 100 may include two FAT instances referred to as FAT1 108 and FAT2 110. The file module 112 may modify the boot sector 206A-B to refer to FAT2 110 as a new FAT1 108. The file module 112 may change a reserved data sector count of the boot sector 206A-B to equal a sum of FAT instances located in the reserved data sector 208B.

The driver module 114 may determine the count of FAT instances 204A-B during at least one of a periodic operation of a dedicated application program interface and a file system mounting operation. The file system mounting operation may occur during a mobile device's booting operation. When a mobile phone is used as a Universal Serial Bus (USB) storage device, the file system mounting may occur when the mobile device is safely decoupled from a computer using a Microsoft® Windows® operating system. The driver module may also periodically update the data in the FAT instance. The driver module 114 may operate as a file system driver for the computer file system 100.

The file module 112 may set the count of FAT instances to one if the count is greater than one. The file module 112 may set a field value to one if an original field value is greater than one. The field value may be a BPB_NumFAT field value, where BPB_NumFAT is a alphanumeric string used in a Microsoft® FAT convention to indicate the count of FAT instances.

The boot module 116 modifies a boot sector 206A-B to refer to a data sector including a FAT as a reserved data sector 208B. The boot module 116 may modify the boot sector 206A-B to refer to a plurality of data sectors including a plurality of FAT instances other than the last FAT instance as the reserved data sector 208B.

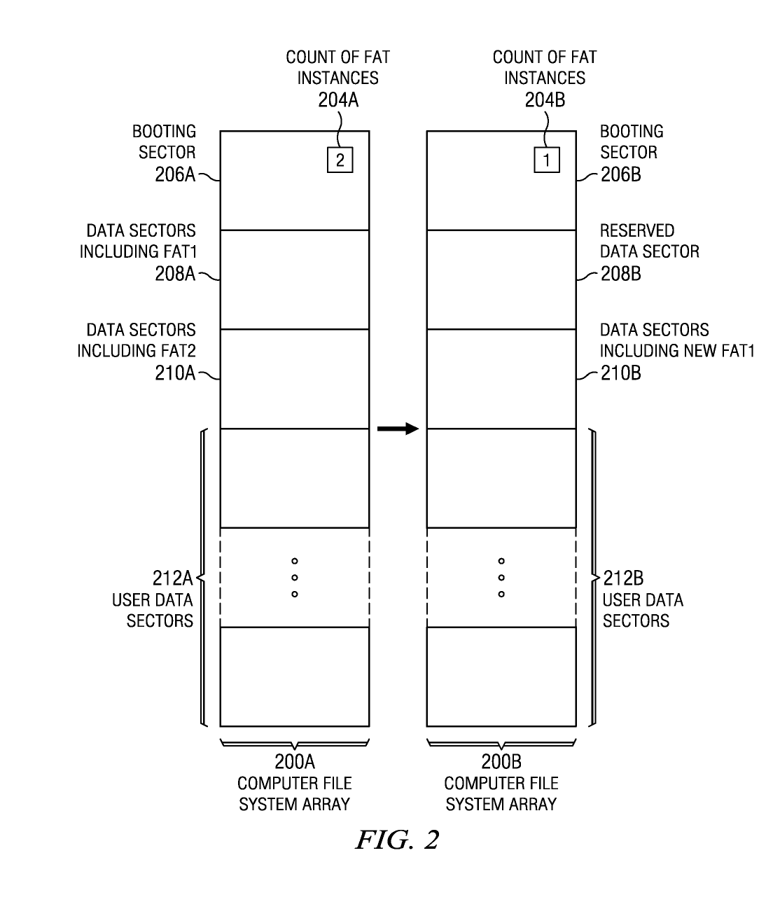

FIG. 2 illustrates a computer file system array 200A-B, a FAT instance 204A-B, a booting sector 206A-B, the data sectors including FAT1 208A, the reserved data sectors including 208B, the data sectors including FAT2 210A, the data sectors including new FAT1 210B, and the user data sectors 212A-B, according to one embodiment.

The computer system file array 200A-B may be a data structure consisting of a group of data sectors that are accessed through a FAT index. The boot sector 206A-B may include a code for a set of operations used to place the computer file system 100 into a normal operating configuration after power is supplied. The boot sector 206A-B may be the first sector of the computer file system array 200A-B. The boot sector 206A-B may include a BIOS parameter block. The BIOS parameter block may be the physical medium (hard disk drive, solid-state drive or a combination thereof) that is stored in a volume boot record of the data storage device 104. The file module 112 may set the count of FAT instances to one if the count is greater than one. A FAT instance 204A-B may be a variable reference found in the boot sector 206A-B that refers to the count FAT instances located in the computer file system array 200A-B. The count of FAT instances 204A-B may be marked in a BPB_NumFAT field of the boot sector 206A-B according of to a Microsoft® FAT document convention. The data sectors containing FAT1 208A may be a count of data sectors containing data, files or subdirectories for a first FAT instance of a sequential count of FAT instances of the computer system file array 200A-B. The reserved data sectors 208B may include a FAT instance that is not updated by the driver module 114. The reserved data sectors 208A-B may be adjacent to the boot sector 206A-B. The data sectors including FAT2 210A may be a number of data sectors including data, files or subdirectories for a second FAT instance of a sequential number of FAT instances of the computer system file array 200A-B. The second FAT instance may be included in the computer file system array 200A-B to provide redundancy. In other embodiments, other FAT instances may also be included in the computer file system array 200A-B.

FIG. 2 is a system view of a computer file system illustrating reduction of FAT instances to one. The driver module 114 may determine a count of FAT instances referred to in the boot sector 206A during a periodic operation of a dedicated application program interface (API) or during the file system mounting. The file system mounting may occur during a booting operation of a mobile communication device or during a removal operation of the mobile communication device from a computer if the mobile communication device is used as a universal serial bus (USB) mass-storage device. If the count is greater than one (in the present embodiment the count is two), the file module 112 then sets the count to one. The boot module 116 may modify the boot sector 206B to refer to the data sectors including FAT1 208A as reserved data sectors 208B. The file module 112 may modify the boot sector 206B to refer to the data sectors including FAT2 210A as the data sectors including a new FAT1 210B. In other embodiments, if there are more than two FAT instances, the boot module 116 may modify the boot sector 206A-B to refer to all of the other data sectors including FAT instances except the data sectors including the last FAT instance as reserved data sectors 208B. The new FAT1 may be a last FAT instance in a sequence of FAT instances included in the computer file system array 200A-B. According to yet another embodiment, the driver module may update only the data sectors including the new FAT1 210B. The driver module may not update a FAT instance included in the reserved data sectors 208B.

FIG. 3 is a process flow illustrating a method for performance optimizations of FATs, according to one embodiment. In operation 302, a boot sector 206A-B may be read to determine a FAT instance count. In operation 304, the count of 204A-B may be set to one if the count is greater than one. In operation 306, the boot sector 206A-B may be modified to refer another data sector 210A including FAT instance as a reserved data sector. For example, in FIG. 2, the boot sector 206A-B is modified to refer to the data sector including FAT1 208A as the reserved data sector 208B. The data sector including FAT2 210A is the other data sector including the last FAT instance.

FIG. 4 is a process flow illustrating a method of configuring a microprocessor 102 to implement a method for performance optimizations of FATs, according to another embodiment. In operation 402, a microprocessor 102 may be configured to determine a count of file allocation table instances. In operation 404, the microprocessor 102 may be configured to set the count to one if the count is greater than one. In operation 406, the microprocessor 102 may be configured to modify the boot sector 206A-B to refer to a data sector including a FAT instance except the last FAT instance as a reserved data sector 208B.

Although the embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry such as CMOS based logic circuitry, firmware, software or any combination of hardware, firmware, or software embodied in a machine readable medium. For example, the various systems and methods may be embodied using transistors, logic gates, and electrical circuits (e.g., application specific integrated (ASIC) circuitry or in Digital Signal Processor (DSP) circuitry).

In addition, it will be appreciated that the various operations, processes, and methods disclosed herein may be embodied in a machine-readable medium or a machine accessible medium compatible with a data processing system, and may be performed in any order. Accordingly, the specification and drawings are to be regarded in an illustrative rather than in a restrictive sense.

What is claimed is:

1. A method of a computer file system comprising:
reading a boot sector to determine a count of file allocation table instances;
setting the count of file allocation table instances referred to in the boot sector to one if the count is greater than one; and
modifying the boot sector to refer to a data sector comprising a file allocation table instance except a last file allocation table instance as a reserved data sector.

2. The method of claim 1, wherein setting the count comprises:
setting the count during at least one of a periodic operation of a dedicated application program interface and a file system mounting.

3. The method of claim 2, wherein setting the count during the file system mounting comprises:
setting the count during at least one of a booting operation of a mobile communication device and a removal operation of the mobile communication device from a computer if the mobile communication device is used as a universal serial bus mass-storage device.

4. The method of claim 3, wherein the reserved data sector is adjacent to the boot sector.

5. The method of claim 4:
wherein the boot sector is a BIOS parameter block that comprises a booting program, and
wherein setting the count of file allocation table instances referred to in the boot sector to one if the count is greater than one comprises setting a field value to one if an original field value is greater than one.

6. The method of claim 5:
further comprising changing the boot sector to refer to an other data sector comprising the last file allocation table instance to comprise a “FAT1” marker.

7. The method of claim 6:
further comprising updating a reserved data sector count in the boot sector to equal a sum of the file allocation table instances located in the reserved data sector.

8. The method of claim 7,
wherein the file system is implemented in a solid-state device memory system.

9. The method of claim 1 further comprising a computer readable medium comprising a set of computer executable instructions adapted to perform the method of claim 1.

10. A system of a computer file system comprising:
a driver module to read a boot sector to determine a count of file allocation table instances;
a boot module to modify the boot sector to refer to a data sector comprising a file allocation table instance except a last file allocation table instance as a reserved data sector; and
a file module to set the count of file allocation table instances referred to in the boot sector to one if the count is greater than one .

11. The system of claim 10, wherein setting the count of file allocation table instances referred to in the boot sector to one if the count is greater than one occurs during at least one of a periodic operation of a dedicated application program interface and a file system mounting.

12. The system of claim 11, wherein the file system mounting occurs during at least one of a booting operation of a mobile communication device and a removal operation of the mobile communication device from a computer if the mobile communication device is used as a universal serial bus mass-storage device.

13. The system of claim 12, wherein the reserved data sector is adjacent to the boot sector.

14. The system of claim 13, wherein the file module sets a field value to one if an original field value is greater than one.

15. The system of claim 14, wherein the boot sector is a BIOS parameter block that comprises a code for a booting program.

16. The system of claim 15, wherein the file module changes the boot sector to refer to the other data sector comprising the last file allocation table instance to comprise a “FAT1” marker.

17. The system of claim 16, wherein the file system is implemented in a solid-state device memory system.

18. The system of claim of claim 17, wherein the driver module updates the file allocation table instance comprising the “FAT1” marker.

19. A method of a computer file system comprising:
configuring a microprocessor to read a boot sector to determine a count of file allocation table instances;
configuring the microprocessor to set the count of file allocation table instances referred to in the boot sector to one if the count is greater than one; and
configuring the microprocessor to modify the boot sector to refer to a data sector comprising a file allocation table instance except a last file allocation table instance as a reserved data sector.

20. The method of claim 19:
further comprising configuring the microprocessor to update a reserved data sector count in the boot sector to equal a sum of the file allocation table instances located in the reserved data sector.
